(19) United States
(12) Patent Application Publication
(10) Pub. No.: US 2010/0161453 A1
(43) Pub. Date: Jun. 24, 2010

(54) PROCESS FOR LOGISTICS MANAGEMENT INVOLVING INVENTORY DRIVER PROFILING

(75) Inventors: Haydn J. Powell, Minooka, IL (US); Luiz C. Calil, Piracicaba (BR); Silvia R. Praconi-Florencio, Piracicaba (BR)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/624,832

(22) Filed: Nov. 24, 2009

Related U.S. Application Data
(60) Provisional application No. 61/193,737, filed on Dec. 19, 2008.

(51) Int. Cl. G06Q 10/00; G06N 5/02

(52) U.S. Cl. 705/29; 706/54

(57) ABSTRACT

A system for creating an inventory profile is disclosed. The system includes a computer system and at least one input device coupled to a processor. The processor is configured to receive inventory data associated with a group of parts within an inventory and classify each part into one class selected from a plurality of classes. The processor determines a number of days of demand coverage associated with each class and compares the number of days of demand coverage with a corresponding demand coverage value. The processor also determines a difference between the number of days of demand coverage for each class and a corresponding demand coverage value and generates an inventory profile reporting the days of demand coverage for each class associated with the group of parts. The inventory profile indicates the difference between the number of days of demand coverage for each class and the corresponding demand coverage value.

### RELATED APPLICATIONS

This application is based upon and claims the benefit of priority from U.S. Provisional Application No. 61/193,737 by Haydn J. Powell et al., filed Dec. 19, 2008, the contents of which are expressly incorporated herein by reference.

### TECHNICAL FIELD

This disclosure relates generally to supply chain management and, more particularly, to a method and system for supply chain management including inventory driver profiling.

### BACKGROUND

Logistics management is the part of supply chain management that provides for the organized movement of materials from their point of origin to their point of consumption. An inventory management plan is an integral part of almost any business that engages in the manufacture, sale, and/or distribution of goods. An effective logistics management plan controls the effective and efficient flow and storage of inventory in order to meet customer needs and reduce overhead costs.

Inventory management typically involves a plurality of interrelated sub-processes that manage and control virtually every aspect associated with the production and delivery of a finished product to an end-user—from the acquisition and distribution of raw materials between a supplier and a manufacturer, to the manufacturing and production of the finished product, through the delivery, distribution, and storage of materials for a retailer or wholesaler, and, finally, to the sale of the finished good to an end-user.

A primary goal of inventory management is to ensure that sufficient product is available to the customer at the time and location required by the customer. While product availability is critical to effective inventory management, another goal of inventory management includes avoidance of excessive inventory in the supply chain. Inventory not only appears as an asset on a corporation's balance sheet, but it also requires additional expense for its protection and storage. By avoiding excessive inventory, effective inventory management plans seek to limit the expenditure of capital resources that fail to provide a high likelihood of potential for return on investment. For example, unsold or overstocked inventory may necessitate additional storage space, maintenance facilities and resources, and expenditure of capital for production, raw material procurement, handling, delivery, etc.

Typically, suppliers of retail and wholesale products focus a majority of time, effort, and capital in researching, developing, manufacturing, marketing, and advertising their product(s). Consequently, many suppliers may not have the experience necessary to effectively and efficiently manage a supply chain. Moreover, as the number of facilities associated with the supply chain increases, the complexity associated with estimating supply chain parameters (e.g., product demand analysis and forecasting, determination of minimum safety stock levels, determination of appropriate distribution requirements planning (DRP) and deployment settings, optimization of shipping routes, facility planning, etc.) also increases. Consequently, suppliers having supply chains that contain (1) multiple facilitates for storing, assembling, or manufacturing parts, (2) vast quantities and variety of parts, and (3) a wide range of part values, may be especially vulnerable to supply chain management inefficiencies.

The increasing complexity required to effectively manage large supply chains has prompted development of inventory management systems and methods. Such methods typically allow a user to model current and anticipated inventory within a supply chain in an effort to reduce unnecessary inventory while adequately anticipating customer needs. One method for managing supply chain parameters is described in U.S. Patent Publication No. 2002/0147622 A1 to Drolet et al. (“the '622 publication”). The '622 publication discloses a supply chain management method, wherein a user may manage a supply chain through the creation of business rules that monitor critical supply chain parameters. The method of the '622 publication discloses generation of alert notifications to inform the user of violation of the subscribed business rules, the notifications allowing supply chain participants to view data associated with the alert through customized report generation. Certain reports created by the system described in the '622 publication provide supply chain management by allowing visibility of the total aggregate demand for parts associated with certain supply chain partners or specific part numbers. These reports may include, among other things, information representative of part identification, available inventory levels, inventory in transit, and current and projected demand.

Although the method and system disclosed in the '622 publication may allow users to view inventory reports for certain supply chain partners and specific parts, and though these reports include available inventory levels, they do no analyze available inventory allocation within the supply chain. The user of the system of the '662 publication may determine inventory levels associated with a specific part or supply chain partner, but there is no determination at what stage in the supply chain the inventory is located. For example, there is no distinction between inventory in storage in a factory and inventory currently under assembly. As a result, while the method described in the '622 publication may provide a general solution for determining inventory demand for partners within the supply chain in certain situations, it may not allow the user to analyze where within the supply chain there may be excess or deficient inventory.

The presently disclosed system and method for determining an inventory profile are directed toward overcoming one or more of the problems set forth above.

### SUMMARY

In one aspect, the present disclosure is directed to a computer-implemented method of creating an inventory profile. The method may include receiving inventory data associated with a group of parts within an inventory and classifying each part of the group of parts into one class selected from a plurality of classes. The method may also include determining a number of days of demand coverage associated with each class and comparing the number of days of demand coverage for each class with a corresponding demand coverage value. Further, the method may include determining a difference between the number of days of demand coverage for each class and a corresponding demand coverage value, and generating an inventory profile reporting the days of demand coverage for each class associated with the group of parts. The inventory profile may indicate the difference between the number of days of demand coverage for each class and the corresponding demand coverage value.

An additional aspect of the present disclosure is directed to a computer-readable medium for use on a computer system, the computer readable medium having computer executable instructions for performing a method of creating an inventory profile. The computer-readable medium includes instructions for receiving inventory data associated with a group of parts within an inventory and classifying each part of the group of parts into one class selected from a plurality of classes. The computer-readable medium also includes instructions for determining a number of days of demand coverage associated with each class and comparing the number of days of demand coverage for each class with a corresponding demand coverage value. Further, the computer-readable medium includes instructions for determining a difference between the number of days of demand coverage for each class and a corresponding demand coverage value, and generating an inventory profile reporting the days of demand coverage for each class associated with the group of parts. The inventory profile may indicate the difference between the number of days of demand coverage for each class and the corresponding demand coverage value.

An additional aspect of the present disclosure is directed to a system for creating an inventory profile. The system may include a computer system and at least one input device coupled to a processor. The processor receives inventory data associated with a group of parts within an inventory and classifies each part of the group of parts into one class selected from a plurality of classes. The processor also determines a number of days of demand coverage associated with each class and compares the number of days of demand coverage for each class with a corresponding demand coverage value. The processor also determines a difference between the number of days of demand coverage for each class and a corresponding demand coverage value and generates an inventory profile reporting the days of demand coverage for each class associated with the group of parts. The inventory profile may indicate the difference between the number of days of demand coverage for each class and the corresponding demand coverage value.

### BRIEF DESCRIPTION OF THE DRAWINGS

FIG. 1 is a block illustration of an exemplary disclosed computer system capable of implementing the method and system disclosed;

FIG. 2 is a flowchart illustration of an exemplary disclosed method; and

FIG. 3 is an exemplary illustration of the disclosed generated inventory profile.

### DETAILED DESCRIPTION

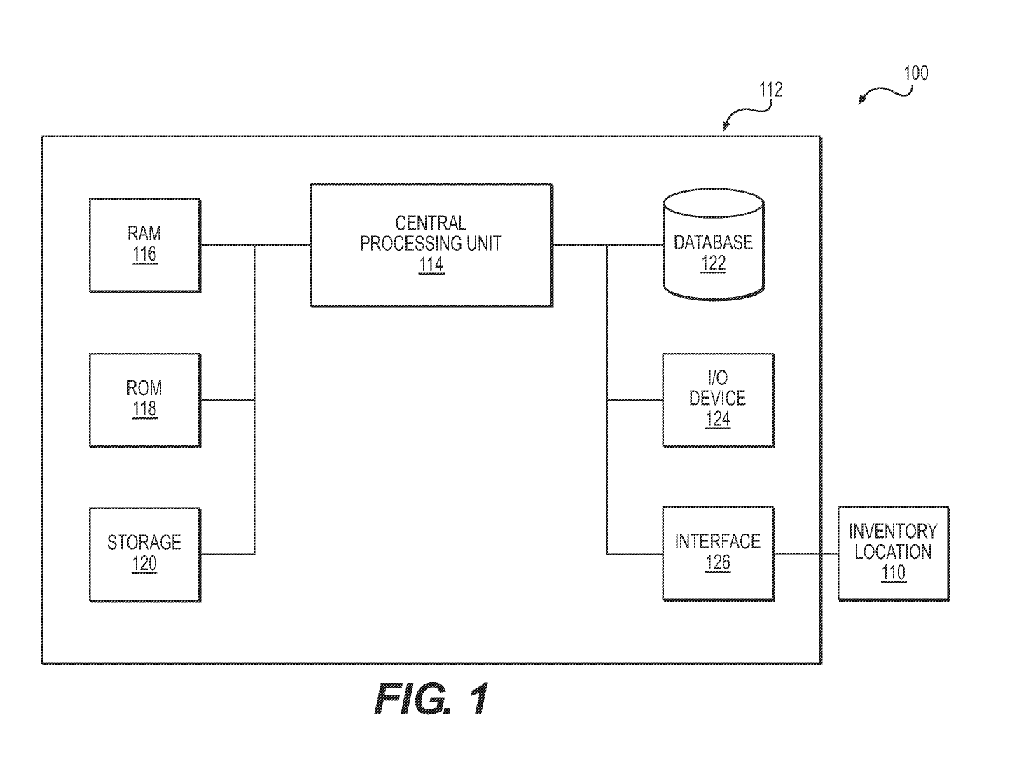

FIG. 1 provides a block diagram illustrating an exemplary disclosed inventory environment 100. Inventory environment 100 may include any type of environment associated with monitoring and managing an inventory. For example, inventory environment 100 may include an inventory location 110 configured to receive and assemble parts into one or more products. As used herein, the term “part” may refer to a portion into which a product is divided, including any material and/or subassembly. A product may be a good that is sold to a customer. For example, if a customer desires to purchase a vehicle, the vehicle may include a plurality of “parts,” such as an engine, fuel system, tires, wheels, a transmission, or any other suitable component of the vehicle. If a customer desires to purchase an engine, the engine may be assembled from one or more parts, such as an engine block, pistons, rods, and a crankshaft. Similarly, pistons may be assembled from one or more parts, and so on, through a supply chain.

Inventory environment 100 may include, among other things, an inventory location 110 containing a plurality of parts and products and a system 112 for maintaining inventory records. Inventory location 110 may include any type of facility for storing or assembling a plurality of parts and products. Inventory location 110 may include, for example, a parts depot, a storage facility, or any other type of facility suitable for storing parts and products. Inventory location 110 may also include, for example, a manufacturing facility or any other type of facility suitable for assembling parts into products. It is contemplated that inventory location 110 may include a geographic region including multiple facilities (e.g., facilities on the eastern coast of the United States), or alternatively, inventory location 110 may include multiple facilities regardless of their geographic location.

System 112 may include any type of processor-based system on which processes and methods consistent with the disclosed embodiments may be implemented. For example, as illustrated in FIG. 1, system 112 may include one or more hardware and/or software components configured to execute software programs. System 112 may include a desktop or portable computer, a workstation, a server, a personal digital assistant, or any other computer system. System 112 may include a central processing unit (CPU) 114, a random access memory (RAM) 116, a read-only memory (ROM) 118, storage 120, a database 122, one or more input/output (I/O) devices 124, and an interface 126. System 112 may include one or more software components such as a computer-readable medium including computer-executable instructions for performing methods consistent with certain disclosed embodiments. One or more of the hardware components listed above may be implemented using software. For example, storage 120 may include a software partition associated with one or more other hardware components of system 112. System 112 may also be configured to store received data and may archive such data for later use. Data may be stored in a database 122, a computer file, paper-based forms, on in computer RAM (e.g., as object data), etc. It is contemplated that the system 112 may include additional, fewer, and/or different components than what is listed above. It is understood that the type and number of devices are exemplary only and not intended to be limiting.

CPU 114 may include one or more processors, each configured to execute instructions and process data to perform one or more functions associated with system 112. As illustrated in FIG. 1, CPU 114 may be communicatively coupled to RAM 116, ROM 118, storage 120, database 122, I/O devices 124, and interface 126. CPU 114 may be configured to execute sequences of computer program instructions to perform various processes, which will be described in detail below. The computer program instructions may be loaded into RAM 116 for execution by CPU 114 from ROM 118. In the exemplary embodiment, the disclosed methods and systems may be implemented as a computer program running on a computer. Furthermore, the methods and systems disclosed herein may be implemented using numerous operating environments such as, but not limited to, DOS, Linus, Windows, VMS, VAX, BeOS, Solaris, OS/2, Macintosh, UNIX, and any other suitable or future developed operating system.

RAM 116 and ROM 118 may each include one or more devices for storing information associated with an operation of system 112 and CPU 114. RAM 116 may include a memory device for storing data associated with one or more operations of CPU 114. For example, ROM 118 may load instructions into RAM 116 for execution by CPU 114. ROM 118 may include a memory device configured to access and store information associated with system 112, including information for identifying, initializing, and monitoring the operation of one or more components and subsystems of system 112.

Storage 120 may include any type of mass storage device configured to store information that CPU 114 may need to perform processes consistent with the disclosed embodiments. For example, storage 120 may include one or more magnetic and/or optical disk devices, such as hard drives, CD-ROMs, DVD-ROMs, or any other type of mass media device.

Database 122 may include one or more software and/or hardware components that cooperate to store, organize, sort, filter, and/or arrange data used by system 112 and CPU 114. Database 122 may contain one or more inventory records associated with each of the plurality of parts stored within inventory location 110. Database 122 may constitute a standalone computer system that includes one or more computer programs for monitoring and maintaining inventory records associated with inventory location 110. Database 122 may also be integrated as part of an inventory location computer or system 112 for maintaining inventory records. It is also contemplated that database 122 may include a shared database between one or more computer systems of business entities associated with inventory location 110, such as an accounting division, a sales division, a supplier, or any other appropriate business entity that may deal with inventory location 110.

For purposes of this disclosure, inventory records may include, among other things, data indicative of part identification to include, for example, a part number, a part name, part description, supplier identification information, and/or any other suitable identification data. Inventory records may also include data relevant to the value of a part or plurality of parts. Value data may include cost data associated with acquiring and maintaining an inventory, and also data that may effect the value of inventory in stock. For example, value data may include, among other things, cost data, annual expenses related to maintaining a part in inventory, quantity of a part in inventory, minimum inventory requirements, time required by the supplier to provide the part, supplier transit time, supplier minimum buy quantities, and/or supplier lot sizes.

Database 122 may also provide inventory records to system 112 that include manufacturer data used to manage inventory. Such information may include, for example, lead time required by the supplier to provide a part, supplier transit time, supplier minimum buy quantities, historical usage data, and/or supplier lot size requirements. Inventory records may also include data associated with inventory location. Inventory location data may include data associated with a part's physical location at a certain locale, for example, a geographic region, a manufacturing facility, a storage site, and assembly position in a manufacturing facility, or any other suitable location for maintaining part.

I/O devices 124 may include one or more components configured to communicate information with a user associated with system 112. For example, I/O devices 124 may include a console with an integrated keyboard and mouse to allow a user to input parameters associated with system 112. I/O devices 124 may also include a display, such as a monitor, including a graphical user interface (GUI) for outputting information. I/O devices 124 may also include peripheral devices such as, for example, a printer for printing information associated with system 112, a user-accessible disk drive (e.g., a USB port, a floppy, CD-ROM, or DVD-ROM drive, etc.) to allow a user to input data stored on a portable media device, a microphone, a speaker system, or any other suitable type of interface device. Although not illustrated, inventory location 110 may also include I/O devices that allow user interaction.

The results of received data may be provided as output from system 112 to I/O device 126 for printed display, viewing, and/or further communication to other system devices. Such output may include, for example, current inventory levels, projected inventory requirements, recommended inventory levels, and inventory profile report. Output from system 112 may also be provided to database 112 in order to track historical inventory records including recommended inventory levels, demand for parts and products, and factors driving inventory. Using this information, it can be determined whether excess or deficient inventory is located within the supply chain, and the recommended inventory levels that would meet manufacturing demands while minimizing inventory costs and overhead.

Interface 126 may include one or more components configured to transmit and receive data via a communication network, such as the Internet, a local area network, a workstation peer-to-peer network, a direct link network, a wireless network, or any other suitable communication platform. In this manner, inventory location 110 and system 112 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 126 may include one or more modulators, demodulators, multiplexers, demultiplexers, network communication devices, wireless devices, antennas, modems, and any other type of device configured to enable data communication via a communication network.

System 112 may analyze and sort inventory records for a plurality of parts into several groups of parts. Groups of parts may include parts associated by part identification information, part location, and/or value. Groups of parts may include, for example, parts with the same or similar part numbers, part names, descriptions, supplier information, and/or any other suitability similar identification data. Groups of parts may also include parts located at the same or similar inventory location 110. As stated above, an inventory location 110 may include any type of facility for storing or assembling a plurality of parts and products. Additionally, groups of parts may include parts associated by value or value stream, and may include inventory sorted into various ranges based on inventory value. For example, ranges of part value may include a high value, mid value, and low value, where high value parts have an associated value above mid value parts, and mid value parts have an associated value above low value parts. Using value data stored in database 122, system 112 may sort parts into various value streams based on a parts respective value.

System 112 may analyze inventory records and classify inventory data for a group of parts into several inventory classes. The different inventory classes may represent a part's status within the supply chain, such as, for example, material and parts acquired for manufacturing, parts undergoing manufacturing and assembly, and completed parts awaiting distribution. For purposes of this disclosure, inventory classes may include, for example, “Manufacturing Pipeline,” “Manufacturing Lot Sizes,” “Cycle Stock,” “Minimum Inventory Balance,” “Manufacturing Past-Due,” “Customer Past-Due,” and “General Overstock.” Inventory classified as Manufacturing Pipeline may include inventory currently in use by the manufacturing process. Inventory included as Manufacturing Pipeline may include inventory driven by manufacturing lead-time, such as, for example, inventory acquired to accommodate manufacturing set-up time. Inventory classified as Manufacturing Lot Sizes may include inventory acquired to accommodate a supplier work order preferences. For example, a supplier may provide oil filters in batches of 100 parts. Although the manufacturing process may require only 75 oil filters, in order to accommodate a supplier's preference, 100 oil filters would be ordered. The 25 excess oil filters would be placed in inventory and classified as Manufacturing Lot Size. Inventory may also be classified as Cycle Stock. Cycle Stock may include inventory available to satisfy the normal demand during a given period. Inventory may also be classified as Minimum Inventory Balance (MIB). MIB inventory is inventory driven by minimum material re-order points as a function of material lead-time, delivery, and demand uncertainty. For example, it would be common to have MIB inventory where material is only available from an overseas supplier where lead-time may be greater and the delivery timeframes may be longer than a domestic supplier's. Inventory may also be classified as Manufacturing Past-Due and/or Customer Past-Due. Manufacturing Past-Due and/or Customer Past-Due inventory may include inventory driven to complete work not yet finished or past-due. Inventory may also be classified as General Overstock. General Overstock inventory may include inventory not classified in another inventory classification. General Overstock inventory may include inventory previously included in another classification. For example, inventory classified as General Overstock may include inventory acquired as Cycle Stock. However, due to changed demand, the inventory is no longer necessary to accommodate anticipated demand and is re-classified from Cycle Stock to General Overstock.

Using assigned inventory classes, system 112 may determine an inventory profile for various groups of parts. An inventory profile may provide a representation of the different classes of inventory assigned to a specific group in terms of days of inventory available. System 112 may present information related to an inventory profile, to a GUI for example, in the form of a visual display, or report, or any other suitable data display method.

System 112 may receive and request inventory records to determine demand coverage values associated with a group or class of parts. System 112 may compare days of demand coverage to demand coverage values in order to identify excess or deficient inventory. System 112 determines days of demand coverage based on the quantity of a part in stock and the quantity required per day to accommodate the manufacturing process. For example, the manufacturing process may require 100 oil filters per day. If the inventory includes 1000 oil filters, there is approximately 10 days of demand coverage available with the current inventory. In this example, if no additional oil filters are added to the inventory, on the tenth day of manufacturing all of the oil filters will be consumed by the manufacturing process, and there will be no remaining oil filters in inventory. System 112 may determine the demand coverage value based on historical demand data associated with the group of parts. Historical demand data may include, for example, demand coverage data associated with previous supply chain cycles for a single part, a group of parts, or a part location.

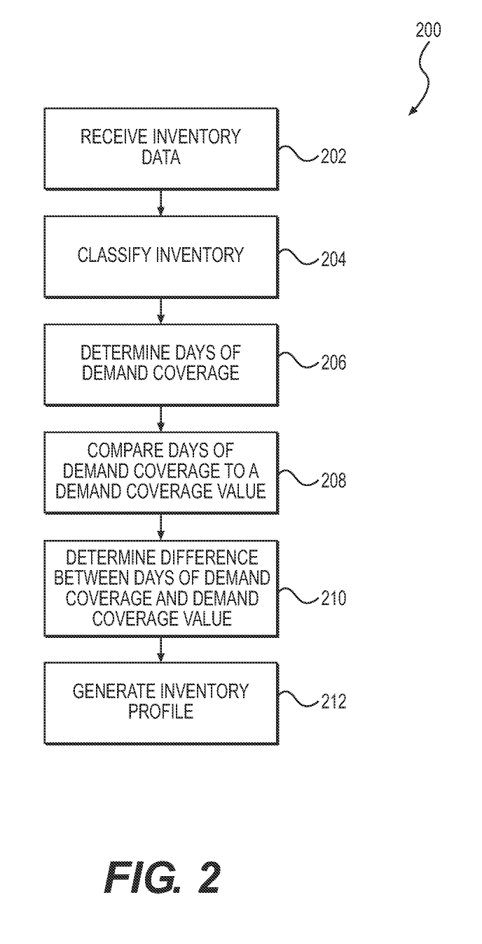

Exemplary processes and methods consistent with the invention will now be described with reference to FIG. 2. FIG. 2 illustrates a flow chart 200 depicting an exemplary method that utilizes system 112 to create an inventory profile for a group of parts. As previously stated, a group of parts may include a plurality of parts having the same part number, a plurality of parts having multiple part numbers, a plurality of parts associated with an inventory location, or a plurality of parts within the same value stream. It is contemplated that the method may alternatively be implemented manually without the use of system 112. As indicated in FIG. 2, the first step of the method may include receiving inventory data associated with a group of parts (step 202). As described above, inventory data may include data indicative of part identification, part value, and/or part location.

Once inventory data has been received for a group of parts, each part within the group may be classified (step 204). Inventory may be classified into one of several classes. As described above, possible classes may include, for example, Manufacturing Pipeline, Manufacturing Lot Sizes, Cycle Stock, Minimum Inventory Balance, Manufacturing Past-Due, Customer Past-Due, and General Overstock.

After the inventory data has been received and the group of parts classified, system 112 may determine the number of days of demand coverage for each of the classes associated with the group of parts (step 206). The days of demand coverage may be a quantity required per day to accommodate the manufacturing process. The days of demand coverage may indicate the number of days until the available inventory quantity will be consumed by the manufacturing process. Days of demand coverage may be determined for each inventory classification. Similarly, days of demand coverage may be determined for a group of parts including part identification, location, or value stream.

System 112 may then compare the days of demand coverage for a particular class with a corresponding demand coverage value (step 208). The demand coverage value may be determined as a quantity sufficient to maintain daily operations and meet projected customer demands. Alternatively, system 112 may receive a demand coverage value for each of the classifications.

Once the days of demand coverage available have been determined for the group of parts, system 112 may then determine the difference between the days of demand coverage and the demand coverage value for each classification (step 210). The demand coverage value may be represented in terms of quantity or days of coverage. For example, the demand coverage value for oil filters may be 100 filters, with oil filters being consumed by the manufacturing process at a rate of 20 filters per day. Therefore, in this example, the demand coverage value may be represented as 5 days of coverage. If the current manufacturing process has 8 days of demand coverage and the demand coverage value is identified as 5 days of coverage, system 112 identifies an excess of 3 days of demand coverage. By comparing days of demand coverage to the demand coverage value for each group of parts and its respective classes, system 112 is able to locate excess or deficient inventory within the supply chain.

System 112 may then generate an inventory profile indicative of the number of days of demand coverage (step 212). The inventory profile may provide a graphical representation of days of demand coverage. The representation may display an inventory profile for various groups of parts. As recited above, groups of parts may include parts associated by part number, part location, and/or inventory value stream. The inventory profile may include identification of the various classes of inventory within the group of parts represented in the inventory profile. System 112 may then present information related to an inventory profile, to a GUI for example, in the form of a visual display, or report, or any other suitable data display method.

After an inventory profile has been generated, a user is able to identify the drivers of excess or deficient inventory associated with the inventory classes. By adjusting inventory to a value more similar to the inventory threshold value, costs associated with excess or deficient inventory are reduced.

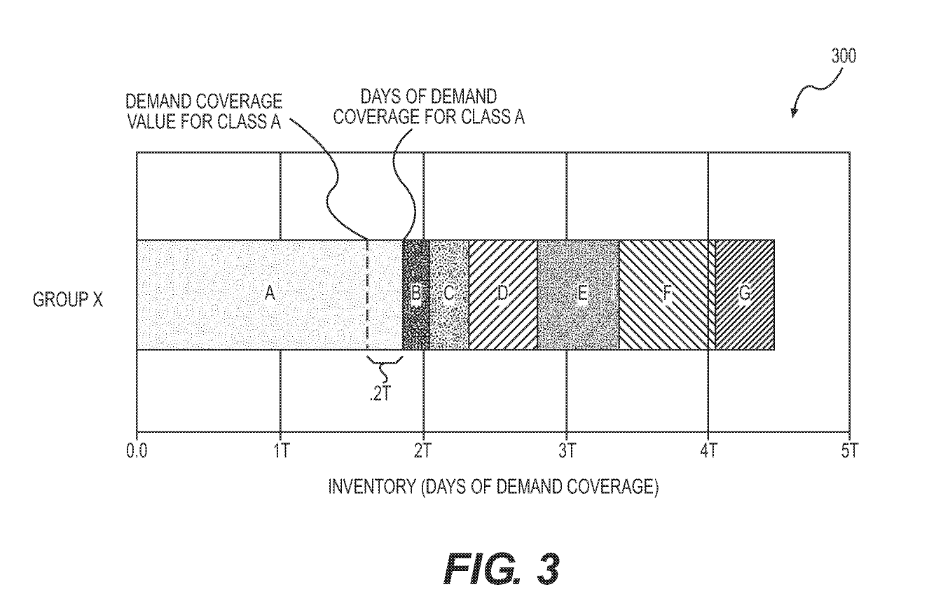

FIG. 3 is an exemplary illustration of the disclosed generated inventory profile 300. As shown in FIG. 3, a generated inventory profile 300 may include a graphical representation of a days of demand coverage for a group of parts. For example, the horizontal axis of the inventory profile may represent days of demand coverage, and the vertical axis may represent a group of parts. As shown in FIG. 3, exemplary generated inventory profile 300 is displayed for inventory Group X, where Group X may represent, for example, part identification, part location, or inventory value stream. Days of demand coverage are illustrated along the x-axis. Days of demand coverage are shown in intervals of 1T, 2T, 3T, 4T, and 5T, where T may be any interval appropriate to represent the complete range of days of demand coverage for the selected category. As shown in FIG. 3, generated inventory profile 300 may include representations of plurality of inventory classes within the selected group of parts. For example, A, B, C, D, E, F, and G may represent days of demand coverage for a respective one of inventory classes Manufacturing Pipeline, Manufacturing Lot Sizes, Cycle Stock, Minimum Inventory Balance, Manufacturing Past-Due, Customer Past-Due, and General Overstock. As shown in FIG. 3, the total days of demand coverage for inventory in category X is approximately 4.5T.

As shown in FIG. 3, exemplary generated inventory profile 300 may indicate the days of demand coverage for an inventory class. For example, as shown in FIG. 3, the days of demand coverage for inventory class A is identified as approximately 1.9T. Similarly, generated inventory profile 300 may indicated the demand coverage value for each class within the selected group of parts. For example, as shown in FIG. 3, the demand coverage value for class A is identified as 1.7T. Additionally, the difference between the demand coverage value and the days of demand coverage may be identified. As shown in FIG. 3, the difference between the days of demand coverage and the demand coverage value for class A is identified as 0.2T.

Those skilled in the art will appreciate that all or part of systems and methods consistent with the present disclosure may be stored on or read from other computer-readable media. Inventory environment 100 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) 118 or random-access memory (RAM) 116. Such computer-readable media may be embodied by one or more components of inventory environment 100, such as inventory database 112, CPU 114, storage 120, database 122, or combinations of these and other components.

The described implementation may include a particular network configuration but embodiments of the present disclosure may be implemented in a variety of data communication network environments using software, hardware, or a combination of hardware and software to provide the processing functions.

### INDUSTRIAL APPLICABILITY

Processes and methods consistent with the disclosed embodiments may provide inventory profiling tools that reduce the potential for unnecessary inventory expenses due to excess or deficient inventory availability. As a result, inventory availability may be managed, excess inventory reduced from the available stock, and recommended quantities of deficient inventory may be acquired. This may allow a manufacturer to maintain sufficient quantities of parts that may be used to assemble products for customers within an acceptable period of time.

Although the disclosed embodiments are described and illustrated as being associated with an inventory environment used to monitor and manage a parts inventory, they may also be applicable to any process where it may be advantageous to monitor and track inventory drivers to identify potential improvements in the performance of inventory management. Furthermore, the systems and methods described herein may be provided as part of a software package that allows users to analyze inventory data and determine associated cost and service level impacts associated with changes in inventory availability.

The presently disclosed systems and methods for creating an inventory profile have several advantages. For example, unlike some conventional methods, the system allows the user to identify, within a supply chain, excess or deficient inventory. Utilizing the system and method of the present disclosure, users may identify inventory drivers associated with specific parts, part locations, and value streams. Identifying inventory drivers within a supply chain allows the user to determine inventory management inefficiencies and identify waste.

Furthermore, the present system and method may have several other advantages. Identifying minimum threshold inventory values and comparing those values to current inventory availability aids in evaluating an accurate determination of current inventory needs. Comparing inventory profiles over time may assist the user to accurately model and forecast future inventory needs. Also, identifying inventory demand coverage values allows the user to identify areas of necessary process improvement, ultimately resulting in reduced inventory expenses and overhead costs.

It will be apparent to those skilled in the art that various modifications and variations can be made to the disclosed systems and methods for creating an inventory profile associated with a supply chain without departing from the scope of the disclosure. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-implemented method of creating an inventory profile comprising:
receiving inventory data associated with a group of parts within an inventory;
classifying each part of the group of parts into one class selected from a plurality of classes;
determining a number of days of demand coverage associated with each class;
comparing the number of days of demand coverage for each class with a corresponding demand coverage value;
determining a difference between the number of days of demand coverage for each class and a corresponding demand coverage value; and
generating an inventory profile reporting the days of demand coverage for each class associated with the group of parts,
wherein the inventory profile indicates the difference between the number of days of demand coverage for each class and the corresponding demand coverage value.

2. The method of claim 1, wherein each of the plurality of classes corresponds to a stage of a supply chain including one or more of material acquisition, manufacturing, and distribution.

3. The method of claim 1, wherein the group of parts includes a plurality of parts having the same part number.

4. The method of claim 1, wherein the group of parts includes a plurality of parts with at least two parts of the plurality of parts having a different part number.

5. The method of claim 1, wherein the group of parts includes a plurality of parts associated with an inventory location.

6. The method of claim 1, wherein the group of parts includes a plurality of parts having a monetary value within a predetermined value range.

7. The method of claim 1, wherein the demand coverage value is determined based on historic demand data associated with the group of parts.

8. A computer-readable medium for use on a computer system, the computer readable medium having computer executable instructions for performing a method of creating an inventory profile, the method comprising:
receiving inventory data associated with a group of parts within an inventory;
classifying each part of the group of parts into one class selected from a plurality of classes;
determining a number of days of demand coverage associated with each class;
comparing the number of days of demand coverage for each class with a corresponding demand coverage value;
determining a difference between the number of days of demand coverage for each class and a corresponding demand coverage value; and
generating an inventory profile reporting the days of demand coverage for each class associated with the group of parts,
wherein the inventory profile indicates the difference between the number of days of demand coverage for each class and the corresponding demand coverage value.

9. The computer-readable medium of claim 8, wherein each of the plurality of classes corresponds to a stage of a supply chain including one or more of material acquisition, manufacturing, and distribution.

10. The computer-readable medium of claim 8, wherein the group of parts includes a plurality of parts having the same part number.

11. The computer-readable medium of claim 8, wherein the group of parts includes a plurality of parts with at least two parts of the plurality of parts having a different part number.

12. The computer-readable medium of claim 8, wherein the group of parts includes a plurality of parts associated with an inventory location.

13. The computer-readable medium of claim 8, wherein the group of parts includes a plurality of parts having a monetary value within a predetermined value range.

14. The computer-readable medium of claim 8, wherein the demand coverage value is determined based on historic demand data associated with the group of parts.

15. A system for creating an inventory profile comprising:
a computer system;
at least one input device coupled to a processor; and
the processor configured to:
receive inventory data associated with a group of parts within an inventory;
classify each part of the group of parts into one class selected from a plurality of classes;
determine a number of days of demand coverage associated with each class;
compare the number of days of demand coverage for each class with a corresponding demand coverage value;
determine a difference between the number of days of demand coverage for each class and a corresponding demand coverage value; and
generate an inventory profile reporting the days of demand coverage for each class associated with the group of parts,
wherein the inventory profile indicates the difference between the number of days of demand coverage for each class and the corresponding demand coverage value.

16. The system of claim 15, wherein each of the plurality of classes corresponds to a stage of a supply chain including one or more of material acquisition, manufacturing, and distribution.

17. The system of claim 15, wherein the group of parts includes a plurality of parts having the same part number.

18. The system of claim 15, wherein the group of parts includes a plurality of parts with at least two parts of the plurality of parts having a different part number.

19. The system of claim 15, wherein the group of parts includes a plurality of parts associated with an inventory location.

20. The system of claim 15, wherein the group of parts includes a plurality of parts having a monetary value within a predetermined value range.
